(19) United States
(12) Patent Application Publication
(10) Pub. No.: US 2018/0065419 A1
(43) Pub. Date: Mar. 8, 2018

(54) PNEUMATIC TIRE

(71) Applicant: TOYO TIRE & RUBBER CO., LTD., Osaka (JP)

(72) Inventor: Yukiko Ueda, Osaka-shi (JP)

(73) Assignee: TOYO TIRE & RUBBER CO., LTD., Osaka (JP)

(21) Appl. No.: 15/494,828

(22) Filed: Apr. 24, 2017

(30) Foreign Application Priority Data
Sep. 7, 2016 (JP) 2016-174669

(51) Int. Cl. B60C 13/02; B60C 11/01

(52) U.S. Cl. CPC B60C 13/02; B60C 11/01

(57) ABSTRACT

In a pneumatic tire, a sidewall portion includes a plurality of projecting portions projecting in a tire width-direction. The projecting portions are placed such that at least portions of the projecting portions are superposed on one of the plurality of blocks in a tire radial-direction as viewed from the tire width-direction. At least one of the plurality of projecting portions includes at least one opening. A depth W of the opening satisfies an equation (H/3≦W≦H+2 mm) with respect to a projecting amount H of the projecting portion.

### CROSS REFERENCE TO RELATED APPLICATIONS

This application claims the benefit of priority of Japanese application no. 2016-174669, filed on Sep. 7, 2016, which is incorporated herein by reference.

### BACKGROUND OF THE INVENTION

### Field of the Invention

The present invention relates to a pneumatic tire having a plurality of projecting portions which project in a tire width-direction.

### Description of the Related Art

There are conventionally known pneumatic tires each having a plurality of projecting portions which project in a tire width-direction (e.g., JP-A-2010-264962). According to a structure of this pneumatic tire, traction performance on a mud area or a rocky area is enhanced due to resistance caused when the projecting portions shear dirt and due to friction between the projecting portions and rock, and resistance to external damage is enhanced due to increase in rubber thickness.

By the way, weight balance of the tire is prone to become uneven due to existence of the projecting portions. Accordingly, when the tire is produced (vulcanized), rubber does not smoothly flow, the tire may be chipped (bare may be generated) with respect to a desired tire shape, or uniformity may be lowered and this may cause vibration or noise of a vehicle.

### SUMMARY OF INVENTION

It is an object of the present invention to provide a pneumatic tire capable of suppressing unevenness of weight balance.

There is provided a pneumatic tire, which includes:

a sidewall portion extending in a tire radial-direction; and

a tread portion having a tread surface on an outer side in the tire radial-direction and connected to an outer end of the sidewall portion in the tire radial-direction, wherein

the tread portion includes a plurality of grooves extending to an outer end in a tire width-direction, and a plurality of blocks arranged in a tire circumferential-direction by being defined by the plurality of grooves,

the sidewall portion includes a plurality of projecting portions projecting in the tire width-direction,

the projecting portions are placed such that at least portions of the projecting portions are superposed on one of the plurality of blocks in the tire radial-direction as viewed from the tire width-direction,

at least one of the plurality of projecting portions includes at least one opening, and

a depth W of the opening satisfies the following equation with respect to a projecting amount H of the projecting portion:

H/3≦W≦H+2 mm.

Also, the pneumatic tire may have a configuration in which:

at least one of the plurality of projecting portions includes a convex portion accommodated in the opening.

Also, the pneumatic tire may have a configuration in which:

the convex portion extends along the tire radial-direction.

Also, the pneumatic tire may have a configuration in which:

the convex portion extends along the tire circumferential-direction.

Also, the pneumatic tire may have a configuration in which:

a tip end of the convex portion is formed into a flat surface shape.

Also, the pneumatic tire may have a configuration in which:

the depth W of the opening satisfies the equation (H/2≦W≦H+2 mm) with respect to the projecting amount H of the projecting portion.

Also, the pneumatic tire may have a configuration in which:

the depth W of the opening satisfies the equation (H/3≦W≦H) with respect to the projecting amount H of the projecting portion.

Also, the pneumatic tire may have a configuration in which:

the depth W of the opening satisfies the equation (H/2≦W≦H) with respect to the projecting amount H of the projecting portion.

Also, the pneumatic tire may have a configuration in which:

a projecting amount of the convex portion is equal to more than ½ of the depth of the opening.

Also, the pneumatic tire may have a configuration in which:

the convex portion includes a top surface placed on a tip end of the convex portion and a pair of side surfaces which intersect with the top surface such that a cross section of the convex portion becomes a trapezoid shape.

Also, the pneumatic tire may have a configuration in which:

an intersection angle between the top surface and the side surfaces is 105° or more and 130° or less.

Also, the pneumatic tire may have a configuration in which:

the convex portion includes a pair of side surfaces such that a cross section of the convex portion becomes a triangular shape.

Also, the pneumatic tire may have a configuration in which:

an intersection angle between the pair of side surfaces is 30° or more and 80° or less.

Also, the pneumatic tire may have a configuration in which:

at least one of projecting portions includes two openings,

the convex portion accommodated in the inner opening in the tire radial-direction extends in the tire circumferential-direction, and

the convex portion accommodated in the outer opening in the tire radial-direction extends in the tire radial-direction.

### BRIEF DESCRIPTION OF THE DRAWINGS

FIG. 1 is a sectional view of essential portions of a tire meridional plane of a pneumatic tire of an embodiment;

FIG. 2 is a front view (as viewed from tire radial-direction) of the pneumatic tire of the embodiment;

FIG. 3 is a side view (as viewed from tire width-direction) of the pneumatic tire of the embodiment;

FIG. 4 is an enlarged sectional view of essential portions taken along line IV-IV of FIG. 3;

FIG. 5 is an enlarged view of a region V in FIG. 4;

FIG. 6 is an enlarged view of a region VI in FIG. 4;

FIG. 7 is a diagram showing a projecting portion of another embodiment;

FIG. 8 is an enlarged sectional view of essential portions taken along line VIII-VIII of FIG. 7;

FIG. 9 is a diagram showing a projecting portion of another embodiment;

FIG. 10 is an enlarged sectional view of essential portions taken along line X-X of FIG. 9;

FIG. 11 is a sectional view of essential portions of the tire meridional plane of the pneumatic tire, and is a view showing a shape when the tire comes into contact with the ground;

FIG. 12 is a diagram showing a projecting portion of another embodiment; and

FIG. 13 is an evaluation table between examples and comparative examples.

### DETAILED DESCRIPTION OF THE PREFERRED EMBODIMENTS

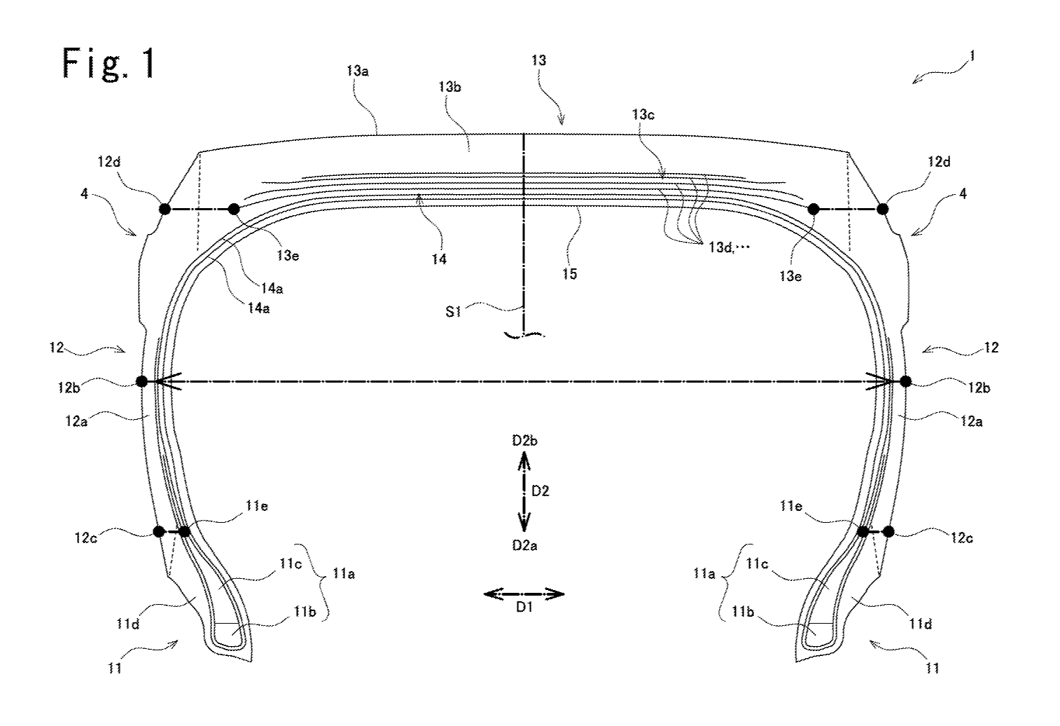

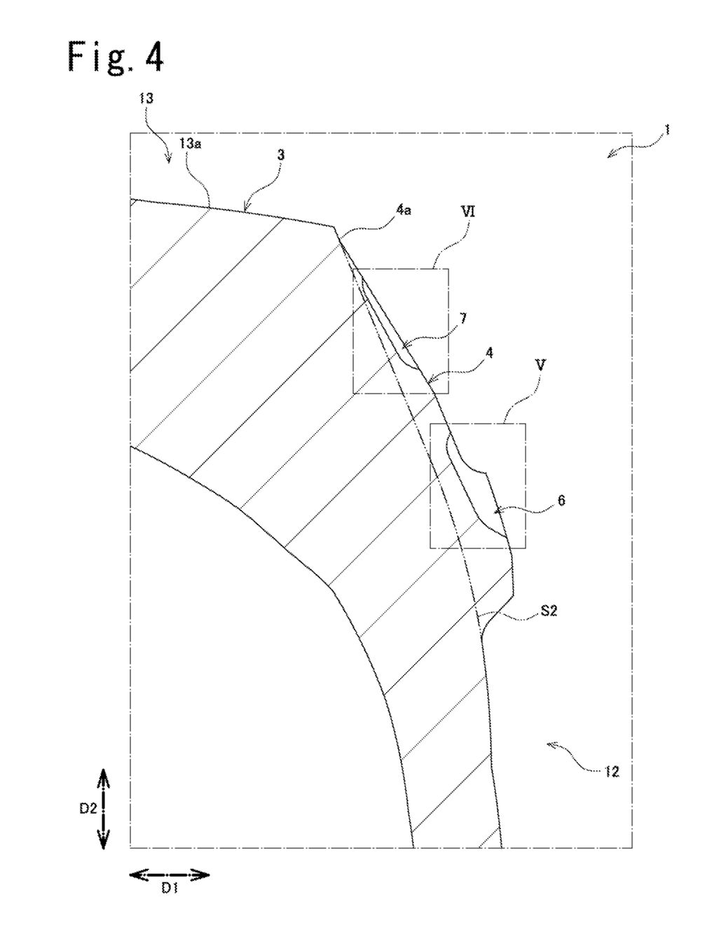

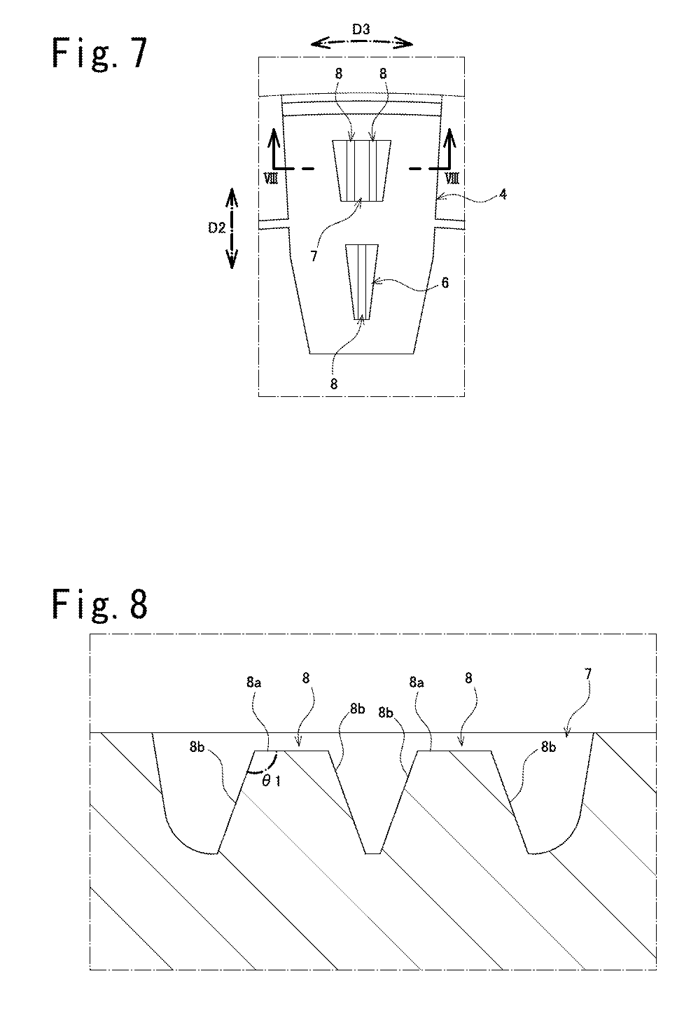

An embodiment of a pneumatic tire will be described below with reference to FIGS. 1 to 6. Size ratios in each of the drawings (including FIGS. 7 to 12) do not always match with actual size ratios, and size ratios between the drawings do not always math with each other.

As shown in FIG. 1, the pneumatic tire (also called “tire” simply) 1 includes a pair of bead portions 11 having beads 11a. The tire 1 includes sidewall portions 12 extending from the bead portions 11 radially outward in a tire radial-direction D2, and a tread portion 13 which is connected to outer ends of the pair of sidewall portions 12 in the tire-radial direction D2. The tread portion 13 is provided with a tread surface 13a which comes into contact with ground. The tread surface 13a is located on the outer side of in a tire radial-direction D2. The tire 1 is mounted on a rim (not shown).

The tire 1 includes a carcass layer 14 extending between the pair of beads 11a and 11a, and an inner linear 15 located on an inner side of the carcass layer 14 and facing an inner space of the tire 1 into which air is charged. The carcass layer 14 and the inner linear 15 are placed along an inner periphery of the tire over the bead portions 11, the sidewall portions 12 and the tread portion 13.

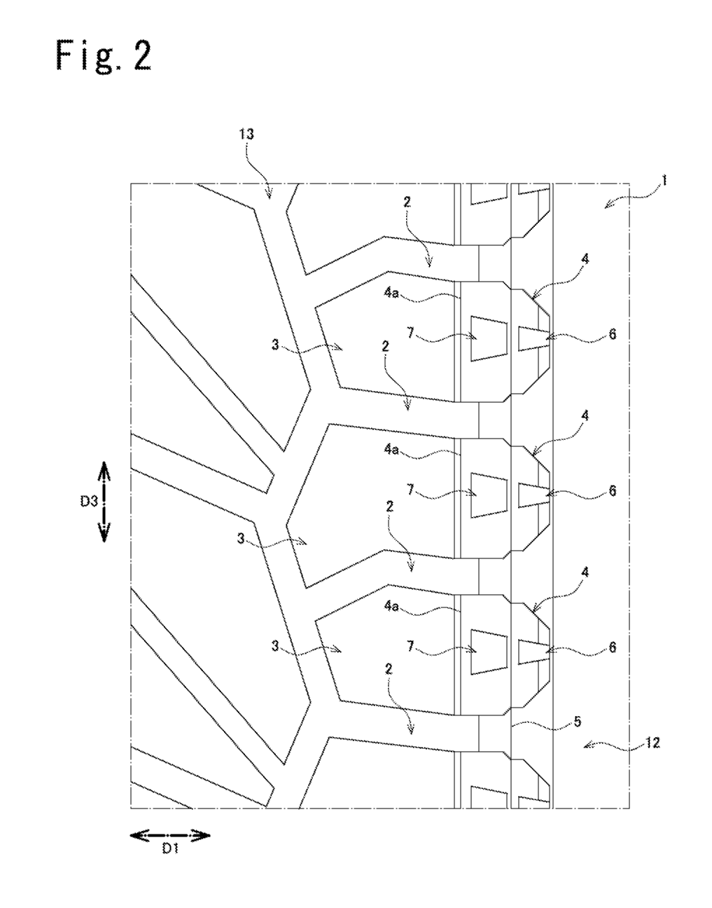

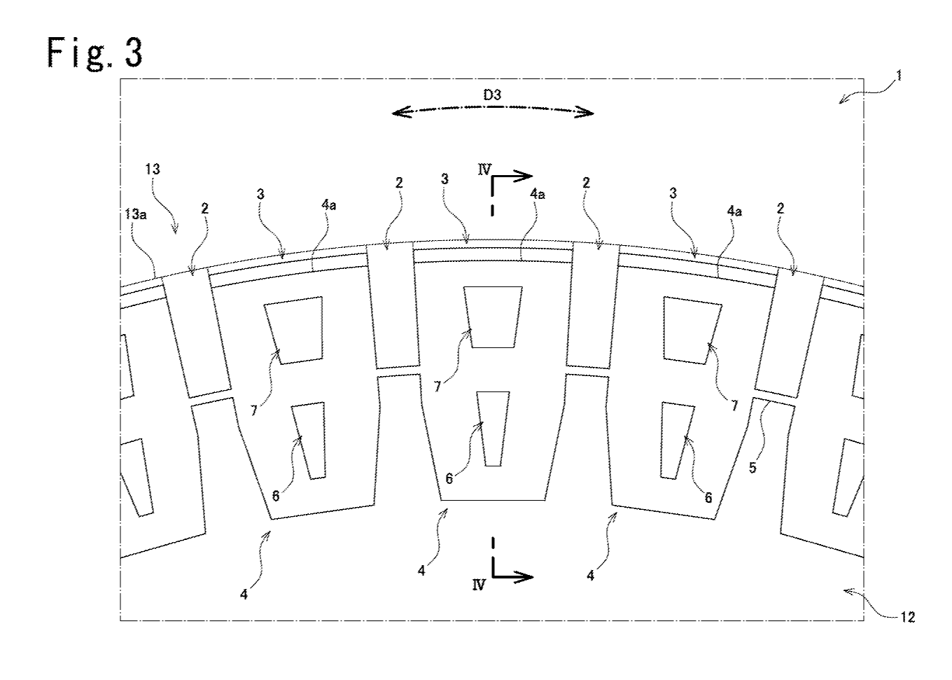

In FIG. 1 (also in the other drawings), a first direction D1 is a tire width-direction D1 which is parallel to the tire rotation axis, a second direction D2 is the tire radial-direction D2 which is a diameter direction of the tire 1, and a third direction D3 (see FIGS. 2 and 3, for example) is a tire circumferential-direction D3 which is a direction around a tire axial-direction. One direction D2a of the second direction D2 is directed inner side of the tire radial-direction D2, and the other direction D2b is directed outer side of the tire radial-direction D2. A tire equator surface S1 is a surface intersecting with the tire rotation axis at right angle, and is located on a center of the tire width-direction D1, and a tire meridional surface is a surface including a surface including the tire rotation axis, and intersecting with the tire equator surface S1.

Each of the beads 11a includes an annularly formed bead core 11b, and a bead filler 11c placed on an outer side of the bead core 11b in the tire radial-direction D2. For example, the bead core 11b is formed by laminating rubber-coated bead wires (metal wires, for example), and the bead filler 11c is formed by forming hard rubber outward of the tire radial-direction D2 in a tapered manner.

Each of the bead portions 11 includes a rim strip rubber 11d placed on an outer side in the tire width-direction D1 than the carcass layer 14 to configure an outer surface which comes into contact with the rim. Each of the sidewall portions 12 includes a sidewall rubber 12a which is placed on an outer side in the tire width-direction D1 than the carcass layer 14 to configure an outer surface.

The tread portion 13 includes a tread rubber 13b. An outer surface of the tread rubber 13b configures the tread surface 13a. The tread portion 13 also includes a belt portion 13c placed between the tread rubber 13b and the carcass layer 14. The belt portion 13c includes a plurality of (four in FIG. 1) belt plies 13d. For example, each of the belt plies 13d includes a plurality of belt cords (organic fiber or metal, for example) which are arranged in parallel, and topping rubbers for coating the belt cords.

The carcass layer 14 is composed of at least one (two in FIG. 1) carcass plies 14a. Each of the carcass plies 14a is folded back around the bead 11a to surround the bead 11a. Each of the carcass plies 14a includes a plurality of ply cords (organic fiber or metal, for example) which are arranged in a direction intersecting with the tire circumferential-direction D3 substantially at right angles, and topping rubbers for coating the ply cords.

To maintain the air pressure, the inner linear 15 has an excellent function to prevent gas from passing through the inner linear 15. In the sidewall portion 12, the inner linear 15 is in intimate contact with an inner periphery of the carcass layer 14, and no other material is interposed between the inner linear 15 and the carcass layer 14.

For example, in a distance between the carcass ply 14a which is placed on the innermost side and a tire inner peripheral surface (inner peripheral surface of inner linear 15), the distance of the sidewall portion 12 is 90% to 180% of the distance of the tread portion 13. More specifically, the distance of the sidewall portion 12 is 120% to 160% of the distance of the tread portion 13.

An outer surface of the sidewall portion 12 has a position 12b which becomes the same, in the tire radial-direction D2, as the tire maximum position (more specifically, maximum distance position of distance of carcass layer 14 between outer sides in tire width-direction D1). The position 12b is called a tire maximum width position 12b, hereinafter.

The outer surface of the sidewall portions 12 has a position 12c which becomes the same, in the tire radial-direction D2, as an outer end 11e of the bead filler 11c in the tire radial-direction D2. The position 12c is called a bead filler outer end position 12c, hereinafter.

The outer surface of the sidewall portions 12 has a position 12d which becomes the same, in the tire radial-direction D2, as an outer end 13e in the tire width-direction D1 in one of the plurality of belt plies 13d which is placed on the innermost side in the tire radial-direction D2. This position 12d is called a belt end position 12d, hereinafter.

As shown in FIGS. 2 to 4, the tread portion 13 includes a plurality of grooves 2 extending to the outer end of the tread portion 13 in the tire width-direction D1, and a plurality of blocks 3 which are defined by the plurality of grooves 2, thereby being arranged in the tire circumferential-direction D3. Each of the sidewall portions 12 includes a plurality of projecting portions 4 projecting from a profile surface (reference surface) S2 in the tire width-direction D1, and an annular protrusion portion 5 projecting from the profile surface S2 in the tire width-direction D1, and extending along the tire circumferential-direction D3.

The projecting portions 4 are placed at least on the outer side in the tire radial-direction D2 of the sidewall portions 12. According to this, the projecting portions 4 can come into contact with mud and sand in a state where the tire 1 sinks due to a weight of the vehicle in a mud area and a sand area, or can come into contact with the uneven rocks in a rocky area. That is, the projecting portions 4 come into contact with the ground in bad roads such as a mud area, a sand area and a rocky area. The projecting portions 4 do not normally come into contact with the ground in a flat road.

The projecting portions 4 are located on an outer side in the tire radial-direction D2 than a bead filler outer end position 12c (see FIG. 1) of the sidewall portion 12. More specifically, the projecting portions 4 are placed on the outer side in the tire radial-direction D2 than a tire maximum width position 12b (see FIG. 1) of the sidewall portion 12.

The projecting portions 4 are placed such that at least portions of them are superposed at least one of the plurality of blocks 3 in the tire radial-direction D2 as viewed from the tire width-direction D1. That is, the projecting portions 4 are superposed on only one of the blocks 3 in the tire radial-direction D2 as viewed from the tire width-direction D1. For example, the projecting portion 4 is superposed on the block 3 in the tire radial-direction D2 as viewed from the tire width-direction D1 by 25% or more in the tire circumferential-direction D3 (preferably 50% or more, more preferably 75% or more).

An outer end 4a of the projecting portion 4 in the tire radial-direction D2 is located on an inner side in the tire radial-direction D2 than the tread surface 13a of the block 3.

According to this, an uneven shape is formed by the tread surface 13a of the block 3 and the outer end 4a of the projecting portion 4 in the tire radial-direction D2.

Since the uneven shape exists, components of the surfaces and the edges are formed. The uneven shape is formed on the portion where the tire comes into contact with the ground such as mud, sand and rock, an area which comes into contact with the ground such as mud, sand and rock is increased, or the surface and the edge formed by the uneven shape easily come into contact with the ground such as mud, sand and rock at various positions. If the uneven shape is formed on the portion where the tire comes into contact with the ground such as mud, sand and rock, the traction performance is enhanced.

Each of the projecting portions 4 includes openings 6 and 7. According to this, a weight of the tire increases due to the existence of the projecting portion 4, and the openings 6 and 7 restrain the weight from increasing. This configuration restrains the weight balance from becoming non-uniform which may be caused by the existence of the projecting portion 4. Due to the existence of the openings 6 and 7, the components of the surfaces and edges are increased and thus, the traction performance is enhanced. The first and second openings 6 and 7 are formed into rectangular shape as viewed from the tire width-direction D1.

The openings 6 and 7 are separated from both end edges of the projecting portion 4 in the tire radial-direction D2. Further, the openings 6 and 7 are separated from the both end edges of the projecting portion 4 in the tire circumferential-direction D3. According to this, since the rigidity of the projecting portion 4 around the openings 6 and 7 can be enhanced, traction performance can be maintained by the projecting portion 4. For example, a width size between the opening edges of the openings 6 and 7 and the end edge of the projecting portion 4 is 1.5 mm or more (preferably, 2.0 mm or more).

The openings 6 and 7 are placed such that they include a center of the projecting portion 4 in the tire circumferential-direction D3. More specifically, central positions of the openings 6 and 7 in the tire circumferential-direction D3 match with the central position of the projecting portion 4 in the tire circumferential-direction D3. The openings 6 and 7 are line-symmetric with respect to center of the projecting portion 4 in the tire circumferential-direction D3. According to this, this configuration restrains the weight balance from becoming non-uniform in the tire circumferential-direction D3, and thus it is possible to restrain the uniformity when the tire is mounted on the vehicle from becoming deteriorated.

Each of the projecting portions 4 includes the two openings 6 and 7. More specifically, the projecting portion 4 includes the first opening 6 placed on the inner side in the tire radial-direction D2 and the second opening 7 placed on the outer side in the tire radial-direction D2. The first opening 6 is placed on the inner side in the tire radial-direction D2 than the annular protrusion portion 5, and the second opening 7 is placed on the outer side in the tire radial-direction D2 than the annular protrusion portion 5.

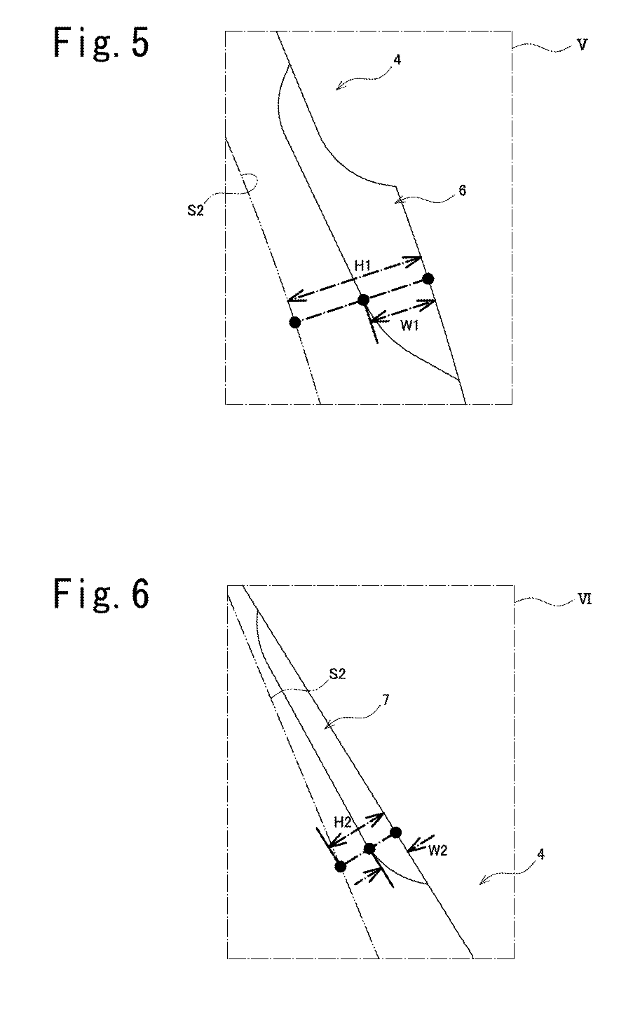

By the way, in each of the projecting portions 4 having the openings 6 and 7, as shown in FIGS. 5 and 6, depths W1 and W2 of the openings 6 and 7 are ⅓ or more of projecting amounts H1 and H2 projecting from the profile surface S2 of the projecting portion 4, and more preferably ½ or more. According to this, since surfaces and edges of the openings 6 and 7 exist, it is possible to enhance the traction performance.

The depths W1 and W2 of the openings 6 and 7 are values (H1+2 mm, H2+2 mm) or less obtained by adding 2 mm to the projecting amounts H1 and H2 from the profile surface S2 of the projecting portion 4, and more preferably less than projecting amounts (H1, H2) from the profile surface S2 of the projecting portion 4. According to this, it is possible to restrain resistance to external damage from being reduced by the fact that a rubber thickness is reduced due to the openings 6 and 7.

Therefore, the depths W (W1, W2) of the openings 6 and 7 satisfy the following relational expression with respect to the projecting amounts (H1, H2) of the projecting portion 4:

H/3≦W≦H+2 mm

more preferably, the depths W (W1, W2) satisfy any of the following relational expressions:

H/2≦W≦H+2 mm

H/3≦W≦H,

and more preferably, the depths W (W1, W2) satisfy the following relational expression:

H/2≦W≦H

In this embodiment, the depths W1 and W2 of the openings 6 and 7 are ½ of the projecting amounts H1 and H2 from the profile surface S2 of the projecting portion 4.

As described above, the pneumatic tire 1 of the embodiment include a sidewall portion 12 extending in a tire radial-direction D2, a tread portion 13 having a tread surface 13a on an outer side in the tire radial-direction D2 and connected to an outer end of the sidewall portion 12 in the tire radial-direction D2. The tread portion 13 includes a plurality of grooves 2 extending to an outer end in a tire width-direction D1, and a plurality of blocks 3 arranged in a tire circumferential-direction D3 by being defined by the plurality of grooves 2. The sidewall portion 12 includes a plurality of projecting portions 4 projecting in the tire width-direction D1. The projecting portions 4 are placed such that at least portions of the projecting portions 4 are superposed on one of the plurality of blocks 3 in the tire radial-direction D2 as viewed from the tire width-direction D1. At least one of the plurality of projecting portions 4 includes at least one openings 6 and 7. A depths W (W1 and W2) of the openings 6 and 7 satisfies the following equation with respect to a projecting amount H (H1 and H2) of the projecting portion 4:

H/3≦W≦H+2 mm.

According to the above-described configuration, the projecting portion 4 is placed such that at least portion of the projecting portion 4 is superposed on at least one of the plurality of blocks 3 in the tire radial-direction D2 as viewed from the tire width-direction D1. Therefore, traction performance is exhibited by a positional relation (e.g., uneven shape) between the block 3 and the projecting portion 4 in the tire width-direction D1.

Due to the existence of the projecting portion 4, the rubber weight of that portion increases. At least one of the plurality of projecting portions 4 includes at least one of the openings 6 and 7. According to this, it is possible to restrain the weight balance from becoming uneven due to the existence of the projecting portion 4. Further, since the depths W of the openings 6 and 7 satisfy the above equations with respect to the projecting amount H of the projecting portion 4, the traction performance is exhibited by the surfaces and edges of the openings 6 and 7, and reduction of the resistance to external damage which may be caused by the existence of the openings 6 and 7 can be restrained.

The pneumatic tire is not limited to the configuration of the embodiment described above, and the effects are not limited to those described above. It goes without saying that the pneumatic tire can be variously modified without departing from the scope of the subject matter of the present invention. For example, the constituents, methods, and the like of various modified examples described below may be arbitrarily selected and employed as the constituents, methods, and the like of the embodiments described above, as a matter of course.

As shown in FIGS. 7 to 10, in the pneumatic tire 1, at least one of the plurality of projecting portions 4 may include the convex portions 8 accommodated in the openings 6 and 7. According to the above-described configuration, since at least one of the plurality of projecting portions 4 includes the convex portions 8 accommodated in the openings 6 and 7, the traction performance is exhibited by the surfaces and edges of the convex portions 8.

As shown in FIGS. 7 and 8, the convex portions 8 may extend along the tire radial-direction D2. According to the above-described configuration, since the convex portions 8 extend along the tire radial-direction D2, resistance when the surface of the convex portion 8 shears becomes great when the convex portions 8 are soaked in mud. According to this, traction performance can be enhanced in a mud area.

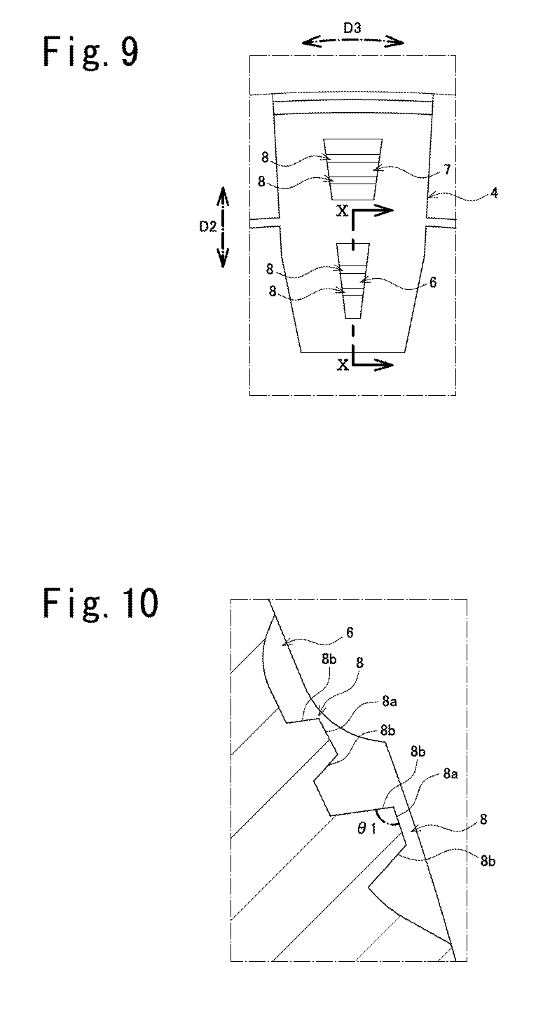

As shown in FIGS. 9 and 10, the convex portions 8 may extend along the tire circumferential-direction D3. According to the above-described configuration, since the convex portions 8 extend along the tire circumferential-direction D3, a friction force between a surface of the convex portion 8 and rock becomes great when the convex portion 8 rides over the rock for example. According to this, traction performance in a rocky area can be enhanced.

As shown in FIGS. 8 and 10, the convex portions 8 may be formed such that tip ends thereof become flat surfaces. For example, the convex portions 8 may be formed such that cross sectional shapes form trapezoidal shapes.

According to the above-described configuration, since the tip ends of the convex portions 8 become flat surfaces, rigidity of the convex portions 8 is increased. According to this, the traction performance caused by the surfaces and the edges of the convex portions 8 can effectively be exhibited. Therefore, traction performance can effectively be enhanced. Further, since it is possible to restrain the openings 8 from being damaged, it is possible to lower the resistance to external damage.

The projecting amounts of the convex portions 8 of FIGS. 8 and 10 are smaller than the depths of the openings 7 and 6. The projecting amounts of the convex portions 8 are ½ or more of the depths of the openings 7 and 6. Each of the convex portions 8 includes a top surface 8a placed on a top end, and a side surface 8b which forms a predetermined intersection angle θ1 with the top surface 8a. It is preferable that the intersection angle θ1 is 105° or more and 130° or less. According to this, it is possible to secure the rigidity of the convex portion 8.

A tip end of the convex portion 8 may be formed into an acute shape. For example, a cross section of the convex portion 8 may be formed into a triangular. According to the above-described configuration, the convex portion 8 does not have the top surface 8a with respect to the convex portion 8 of FIGS. 8 and 10, and includes only a pair of side surfaces 8b and 8b. It is preferable that the intersection angle between the pair of side surfaces 8b and 8b is 30° or more and 80° or less. According to this, it is possible to secure the rigidity of the convex portion 8.

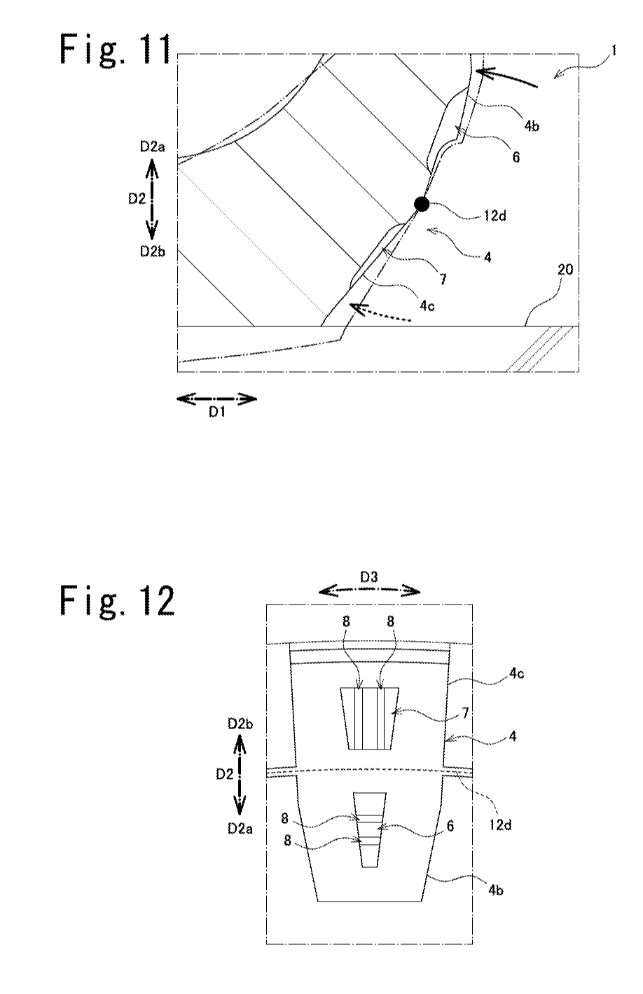

As shown in FIG. 11, when the tire 1 mounted on the vehicle comes into contact with the ground 20, the tire 1 becomes deformed by the weight of the vehicle and the like. In FIG. 11, dashed-two dotted lines show shapes before the tire is deformed, and solid lines show shapes after deformation. At this time, the tire 1 generally becomes deformed differently from the belt end position 12d as a reference.

Specifically, an inner region 4b placed on the inner side in the tire radial-direction D2 with respect to the belt end position 12d becomes deformed such that the inner region 4b is oriented sideways as shown by a solid arrow, and an outer region 4c placed on the outer side in the tire radial-direction D2 with respect to the belt end position 12d becomes deformed such that the outer region 4c is oriented to the ground 20 as shown by a broken arrow. Therefore, the first opening 6 in the inner region 4b acts advantageously for traction when it comes into contact with the ground, i.e., rock which stands from the ground 20, and the second opening 7 in the outer region 4c acts advantageously for traction when it comes into contact with the ground, i.e., with mud accumulated on the surface of the ground 20.

Hence, as shown in FIG. 12, it is possible to employ such a configuration that convex portions 8 accommodated in the first opening 6 of the inner region 4b extend along the tire circumferential-direction D3 to enhance traction performance in a rocky area, and convex portions 8 accommodated in the second opening 7 of the outer region 4c extend along the tire radial-direction D2 to enhance traction performance in a mud area. According to the above-described configuration, it is possible to efficiently enhance traction performance in a rocky area and traction performance in a mud area.

In the pneumatic tire 1 of the embodiments, two openings 6 and 7 may be provided in one projecting portion 4. However, the pneumatic tire is not limited to this configuration. For example, one or three or more openings may be provided in one projecting portion 4.

In the pneumatic tire 1 of the embodiments, the openings 6 and 7 are formed into rectangular shapes as viewed from the tire width-direction D1. However, the pneumatic tire is not limited to this configuration. For example, the openings may be formed into a circular (perfect circular, elliptic) shape as viewed from the tire width-direction D1. Further, for example, the openings may be formed into a triangular shape or a polygonal shape having five angle portions or more as viewed from the tire width-direction D1.

In the pneumatic tire 1 of the embodiments, the openings 6 and 7 are provided in all of the projecting portions 4. However, the pneumatic tire is not limited to this configuration. For example, it is only necessary that the openings 6 and 7 are provided at least in one of the plurality of projecting portions 4. It is preferable that the openings 6 and 7 are provided at least in ¼ of the plurality of projecting portions 4, it is more preferable that the openings 6 and 7 are provided at least in ⅓, and it is more preferable that the openings 6 and 7 are provided at least in ½.

In the pneumatic tire 1 of the embodiments, all of the projecting portions 4 have the same shapes, and all of the openings 6 and 7 have the same shape. However, the pneumatic tire is not limited to this configuration. The projecting portions 4 may have different shapes, and they may be placed in series in the tire circumferential-direction D3. Further, the openings 6 and 7 may have a plurality of different shapes, and may be placed in the respective projecting portions 4 in series in the tire circumferential-direction D3.

In the pneumatic tire 1 of the embodiments, the openings 6 and 7 are respectively separated from both end edges of the projecting portion 4 in the tire radial-direction D2. However, the pneumatic tire is not limited to this configuration. The openings 6 and 7 may be separated only from one of the end edges of the projecting portion 4 in the tire radial-direction D2.

In the pneumatic tire 1 of the embodiments, the openings 6 and 7 are respectively separated from both end edges of the projecting portion 4 in the tire circumferential-direction D3. However, the pneumatic tire is not limited to this configuration. The openings 6 and 7 may be separated only from one of the end edges of the projecting portion 4 in the tire circumferential-direction D3.

In the pneumatic tire 1 of the embodiments, the projecting portions 4 are provided on both of the pair of sidewall portions 12. However, the pneumatic tire is not limited to this configuration. For example, the projecting portions 4 may be provided on one of the pair of sidewall portions 12. For example, the projecting portions 4 may be provided on at least one of the pair of sidewall portions 12 which is placed on the outer side when the tire is mounted on the vehicle.

The pneumatic tire 1 may employ such as configuration that the projecting portions 4 are provided on both of the pair of sidewall portions 12 but the openings 6 and 7 are provided on one of or both of the sidewall portions 12. For example, the openings 6 and 7 may be provided on one of the pair of sidewall portions 12 which is placed on the outer side when the tire is mounted on the vehicle.

### EXAMPLE

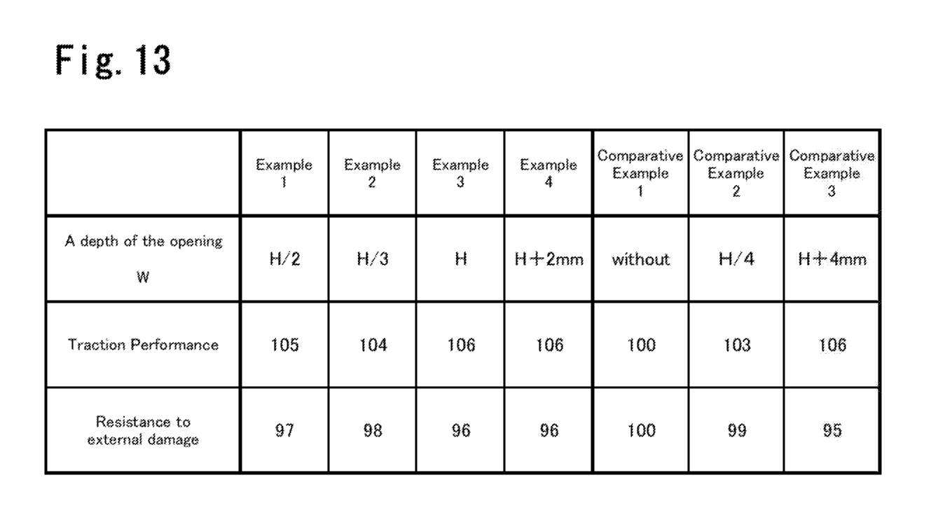

To specifically show the configuration and effect of the tire, Examples and Comparative Examples will be described below with reference to FIG. 13.

<Traction Performance>

Tires having sizes of P265/70R17 were mounted on a vehicle F150, the tires were soaked in a mud pool having depth of 5 cm and length of 10 m, the tires were once stopped, and time elapsed until the tires were escaped from the mud pool was measured. Results of Comparative Example 1 are evaluated as 100 as indices.

The higher the indices are (time elapsed until tires were escaped from the mud pool is shorter), the more excellent the traction performance is.

<Resistance to External Damage>

Tires having sizes of P265/70R17 were mounted on a vehicle F150, the tires were made to collide against a curb five times in a state where the vehicle runs at 10 km/Hr, and a chipped amount at that time was measured. Results of Comparative Example 1 are evaluated as 100 as indices. The higher the indices are (as chipped amount is smaller) the more excellent the resistant to external damage is.

### Examples 1 to 4

Example 1 is a tire of the embodiment shown in FIGS. 1 to 6. That is, in Example 1, a depth W of the opening is ½ of a projecting amount H of the projecting portion.

Example 2 is a tire in which the depth W of the opening of the tire of Example 1 is changed to ⅓ of the projecting amount H of the projecting portion.

Example 3 is a tire in which the depth W of the opening of the tire of Example 1 is the same as the projecting amount H of the projecting portion.

Example 4 is a tire in which the depth W of the opening of the tire of Example 1 is changed to value obtained by adding 2 mm to the projecting amount H of the projecting portion.

### Comparative Examples 1 to 3

Comparative Example 1 is a tire in which the tire of the Example 1 is changed to a configuration having no openings.

Comparative Example 2 is a tire in which the depth W of the opening of the tire of Example 1 is changed to ¼ of the projecting amount H.

Comparative Example 3 is a tire in which the depth W of the opening of the tire of Example 1 is changed to value obtained by adding 4 mm to the projecting amount H of the projecting portion.

<Evaluation Results>

As shown in FIG. 13, according to Comparative Example 2, reduction of resistance to external damage is less than 5% (1%) and enhancement of traction performance is less than 4% (3%) as compared with Comparative Example 1. In Comparative Example 3, as compared with Comparative Example 1, enhancement of traction performance is 4% or more (6%) but reduction of the resistance to external damage exceeds 4% (5%).

In Examples 1 to 4, enhancement of the traction performance is 4% or more and reduction of resistance to external damage is 4% or less as compared with Comparative Example 1. Therefore, according to Examples 1 to 4, traction performance can be enhanced, and reduction of resistance to external damage can be restrained. In this manner, by employing the configuration that the depth W of the opening establishes the following equation with respect to the projecting amount H of the projecting portion, traction performance can be enhanced, and reduction of resistance to external damage can be restrained.

H/3≦W≦H+2 mm.

An Example of a more preferable tire will be described below.

According to Example 2, reduction of resistance to external damage is 4% or less (2%) but enhancement of traction performance is less than 5% as compared with Comparative Example 1. Although it is not appeared in the evaluation results, since openings of Example 4 reach the profile surfaces, resistance to external damage is reduced in Example 4.

According to Examples 1 and 3, enhancement of traction performance is 5% or more and reduction of resistance to external damage is 4% or less as compared with Comparative Example 1, and balance of the enhancement and reduction is excellent. In addition, the openings do not reach the profile surface. Since it is possible to effectively enhance the traction performance and restrain the reduction of resistance to external damage, it is preferable to employ the configuration that the depth W establishes the following equation with respect to the projecting amount H of the projecting portion.

H/2≦W≦H

What is claimed is:

1. A pneumatic tire comprising:
a sidewall portion extending in a tire radial-direction; and
a tread portion having a tread surface on an outer side in the tire radial-direction and connected to an outer end of the sidewall portion in the tire radial-direction, wherein
the tread portion includes a plurality of grooves extending to an outer end in a tire width-direction, and a plurality of blocks arranged in a tire circumferential-direction by being defined by the plurality of grooves,
the sidewall portion includes a plurality of projecting portions projecting in the tire width-direction,
the projecting portions are placed such that at least portions of the projecting portions are superposed on one of the plurality of blocks in the tire radial-direction as viewed from the tire width-direction,
at least one of the plurality of projecting portions includes at least one opening, and
a depth W of the opening satisfies the following equation with respect to a projecting amount H of the projecting portion:
H/3≦W≦H+2 mm.

2. The pneumatic tire according to claim 1, wherein at least one of the plurality of projecting portions includes a convex portion accommodated in the opening.

3. The pneumatic tire according to claim 2, wherein the convex portion extends along the tire radial-direction.

4. The pneumatic tire according to claim 2, wherein the convex portion extends along the tire circumferential-direction.

5. The pneumatic tire according to claim 2, where a tip end of the convex portion is formed into a flat surface shape.

6. The pneumatic tire according to claim 1, wherein the depth W of the opening satisfies the following equation with respect to the projecting amount H of the projecting portion:
H/2≦W≦H+2 mm.

7. The pneumatic tire according to claim 1, wherein the depth W of the opening satisfies the following equation with respect to the projecting amount H of the projecting portion:
H/3≦W≦H.

8. The pneumatic tire according to claim 1, wherein the depth W of the opening satisfies the following equation with respect to the projecting amount H of the projecting portion:
H/2≦W≦H.

9. The pneumatic tire according to claim 2, wherein a projecting amount of the convex portion is equal to more than ½ of the depth of the opening.

10. The pneumatic tire according to claim 5, wherein the convex portion includes a top surface placed on a tip end of the convex portion and a pair of side surfaces which intersect with the top surface such that a cross section of the convex portion becomes a trapezoid shape.

11. The pneumatic tire according to claim 10, wherein an intersection angle between the top surface and the side surfaces is 105° or more and 130° or less.

12. The pneumatic tire according to claim 2, wherein the convex portion includes a pair of side surfaces such that a cross section of the convex portion becomes a triangular shape.

13. The pneumatic tire according to claim 12, wherein an intersection angle between the pair of side surfaces is 30° or more and 80° or less.

14. The pneumatic tire according to claim 2, wherein at least one of projecting portions includes two openings,
the convex portion accommodated in the inner opening in the tire radial-direction extends in the tire circumferential-direction, and
the convex portion accommodated in the outer opening in the tire radial-direction extends in the tire radial-direction.
